(19) United States
(12) Patent Application Publication
(10) Pub. No.: US 2011/0107586 A1
(43) Pub. Date: May 12, 2011

(54) METHOD OF MAKING AN EARTH-BORING PARTICLE- MATRIX ROTARY DRILL BIT

(75) Inventors: Heeman Choe, Kyungki Do (KR); Andreas Mortensen, Saint-Saphorin sur Morge (CH)

(73) Assignee: BAKER HUGHES INCORPORATED, Houston, TX (US)

(21) Appl. No.: 13/007,762

(22) Filed: Jan. 17, 2011

Related U.S. Application Data
(62) Division of application No. 12/340,871, filed on Dec. 22, 2008.

(51) Int. Cl. B23P 15/28

(52) U.S. Cl. 29/527.1

(57) ABSTRACT

A method of making an earth-boring rotary drill bit comprising a bit body configured to carry a cutter for an earth formation includes providing a plurality of hard particles in a mold to define a particle precursor of the bit body; wherein the particle precursor is configured for infiltration by a molten matrix material, the resulting particle-matrix composite material having a first coefficient of thermal expansion. The method also includes disposing an insert within the particle precursor, the insert having a second coefficient of thermal expansion that is greater than the first coefficient of thermal expansion. The method further includes infiltrating the particle precursor of the bit body and insert with the molten matrix material and cooling the molten particle-matrix mixture to solidify the molten matrix material and form a bit body comprising a particle-matrix composite material having a plurality of hard particles and an insert disposed in the matrix material.

### CROSS-REFERENCES TO RELATED APPLICATIONS

This patent application is a divisional of and claims priority to U.S. patent application Ser. No. 12/340871, filed Dec. 22, 2008 which is incorporated herein by reference in its entirety.

### BACKGROUND

One configuration of a rotary drill bit is the fixed-cutter bit, often referred to as a “drag” bit. These bits generally include an array of cutting elements secured to a face region of the bit body. The cutting elements of a fixed-cutter type drill bit generally have either a disk shape or a substantially cylindrical shape. A hard, superabrasive material, such as mutually bonded particles of polycrystalline diamond, may be provided on a substantially circular end surface of each cutting element to provide a cutting surface. Such cutting elements are often referred to as “polycrystalline diamond compact” (PDC) cutters. Typically, the cutting elements are fabricated separately from the bit body and secured within pockets formed in the outer surface of the bit body. A bonding material, such as an adhesive or a braze alloy, may be used to secure the cutting elements to the bit body. A fixed-cutter drill bit is placed in a borehole such that the cutting elements are in contact with the earth formation to be drilled. As the drill bit is rotated, the cutting elements scrape across and shear away the surface of the underlying formation.

The bit body of a fixed-cutter drill bit may be formed from steel. Alternatively, the bit body may be formed from a particle-matrix composite material. Such materials include hard particles randomly dispersed throughout a matrix material (often referred to as a “binder” material.) Particle-matrix composite material bit bodies may be formed by embedding a metal blank in a carbide particulate material volume, such as particles of tungsten carbide, and then infiltrating the particulate carbide material with a matrix material, such as a copper alloy.

Drill bits that have a bit body formed from such particle-matrix composite materials offer significant advantages over all-steel bit bodies, including increased erosion and wear resistance, but generally have relatively lower strength and toughness that limit their use in certain applications. In particularly harsh drilling environments involving complex loading of the drill bit, particle-matrix composite bit bodies subject to extremes of cyclical loading are known to be subject to various forms of cracking. Once a crack is initiated, further cyclical loading can cause the crack to propagate through the matrix and can lead to premature failure of the bit. Such failures are costly, as they generally require cessation of drilling while the drill string, drill bit, or both, are removed from the borehole for repair or replacement of the drill bit. Referring to FIGS. 1A-1C, examples of crack types that have been observed are indicated by arrows and include radial cracks that are associated with the nozzle/port (FIG. 1A), radial cracks that are associated with the cutter pocket (FIG. 1B) and cracks within the blade, particularly those associated with the root of the external channels or junk slots (FIG. 1C).

Therefore, improvement of particle-matrix composite bit bodies to increase the toughness, strength or other properties and reduce the occurrence of cracking during drilling would be desirable and would increase the applications where such bit bodies may be used.

### SUMMARY

An improved method of making an earth-boring rotary drill bit having a particle-matrix composite bit body having an insert, or multiple inserts, disposed therein to improve resistance to cracking within the bit body is disclosed. The method of making an earth-boring rotary drill bit includes a method of making a bit body of the type described herein configured to carry one or more cutters for engaging a subterranean earth formation. The method includes providing a plurality of hard particles in a mold to define a particle precursor of the bit body that is configured for infiltration by a molten matrix material, and the resulting particle-matrix composite material has a first coefficient of thermal expansion. The method also includes disposing an insert within the particle precursor, the insert having a second coefficient of thermal expansion that is greater than the first coefficient of thermal expansion. Further, the method also includes infiltrating the particle precursor of the bit body and insert with molten matrix material. Still further, the method also includes cooling the molten particle-matrix mixture to solidify the matrix material and form a bit body comprising a particle-matrix composite material having a plurality of hard particles and one or several inserts disposed in the matrix material. Still further, the method also includes disposing the inserts such that they will impede cracking within the drill bit body during drilling.

### BRIEF DESCRIPTION OF THE DRAWINGS

The following is a brief description of the drawings:

FIG. 1A is a photograph of a particle-matrix composite used in an earth-boring rotary drill bit that exhibited radial cracking in the nozzle/port region of the bit body;

FIG. 1B is a photograph of a particle-matrix composite used in an earth-boring rotary drill bit that exhibited radial cracking in the cutter pocket region of the bit body;

FIG. 1C is a photograph of a particle-matrix composite used in an earth-boring rotary drill bit that exhibited radial cracking in the route of the external channels or junk slots region of the bit body;

FIG. 2 is a schematic partial cross-sectional view of an exemplary embodiment of a earth-boring rotary drill bit as disclosed herein;

FIGS. 3A-C are schematic partial cross-sectional views illustrating various stages of a method of making an earth-boring rotary drill bit disclosed herein;

FIG. 4 is a schematic illustration of the crack bridging and crack blunting mechanism as disclosed herein;

FIG. 5 is a table illustrating the coefficient of thermal expansion of a matrix material and exemplary insert materials as disclosed herein; and

FIG. 6 is an enlarged cross-sectional view of region 5 of FIG. 2.

### DETAILED DESCRIPTION

Except for photographs, the illustrations presented herein, are not meant to be actual views of any particular material, apparatus, system, or method, but are merely idealized representations of that which is disclosed herein. Additionally, elements common between figures may retain the same numerical designation.

As used herein, the term “[metal]-based alloy” (where [metal] is any metal) means commercially pure [metal] in addition to [metal] alloys wherein the weight percentage of [metal] in the alloy is greater than the weight percentage of any other component of the alloy. Where two or more metals are listed in this manner, the weight percentage of the listed metals in combination is greater than the weight percentage of any other component of the alloy.

As used herein, the term “material composition” means the chemical composition and microstructure of a material. In other words, materials having the same chemical composition but a different microstructure are considered to have different material compositions.

As used herein, the term “tungsten carbide” means any material composition that contains chemical compounds of tungsten and carbon in any stoichiometric or non-stoichiometric ratio or proportion, such as, for example, WC, W₂C, and combinations of WC and W₂C. Tungsten carbide includes any morphological form of this material, for example, cast tungsten carbide, sintered tungsten carbide, and macrocrystalline tungsten carbide.

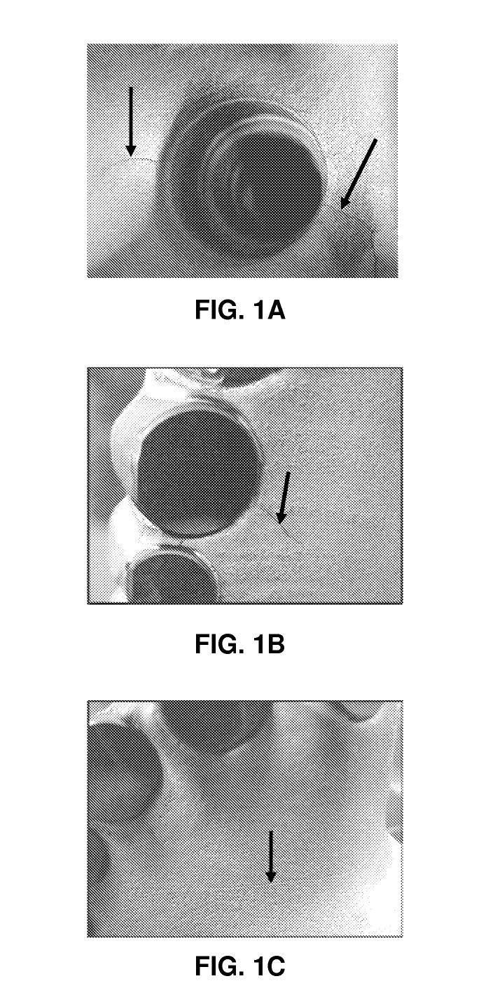

Particle-matrix composite bit bodies are used in drill bits for earth-boring applications in very extreme conditions, including extremes of cyclical loading and temperature. Under these extreme use conditions, cracking has been observed to occur. In particular, certain regions of the particle-matrix composite bit bodies have shown a propensity for cracking which may be a result of higher loading and resultant stresses in these regions. One portion of the bit bodies that has shown a propensity for cracking includes regions surrounding and proximate to the various nozzles/ports of the bit body where radial cracks have been observed (FIG. 1A), which may be related to hoop (tensile) stresses associated with the pumping of pressurized hydraulic drilling fluid through the port/nozzle. Another portion of the bit bodies that has shown a propensity for cracking includes regions surrounding and proximate to the respective cutter pockets where cracks have been observed to radiate away from the pocket, including in a direction roughly perpendicular to the surface of the pocket (FIG. 1B), and which may be related to resultant shear or hoop stresses (tensile stresses) in these regions of the bit body as the respective rotating cutters engage various earth formations and experience shear forces as they engage the earth formations and lateral compressive forces (i.e., transverse to the longitudinal axis of the drill bit and drill string) as the drill string and bit, including the cutters, is advanced through the various earth formations during drilling. Yet another portion of the bit bodies that has shown a propensity for cracking includes regions of the bodies from which the blades protrude which are also associated with the root of external channels or junk slots where cracking has been observed to radiate from the root into the bit body generally underneath the blade (FIG. 1C), and which may be associated with the concentration of tensile forces in these regions as the cutters and their respective blades engage various earth formations. This cracking can result in failure of the drill bit necessitating removal of the drill bit and drill string. The removal of the drill string and drill bit for replacement is very costly, hence, it is desirable to reduce or eliminate such cracking, particularly in regions of the bit body that have a particular propensity for the same.

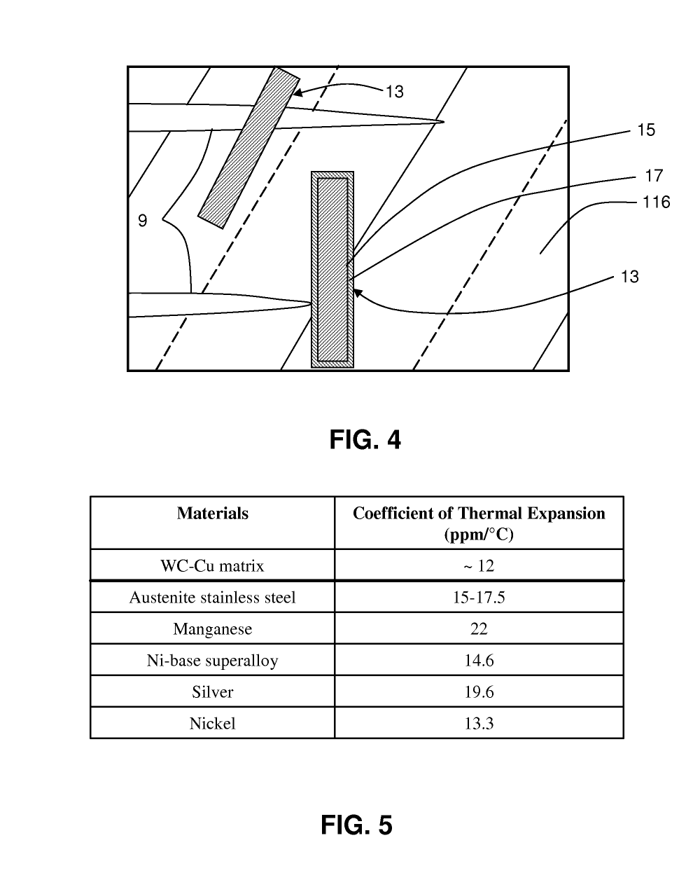

Thus, an improved earth-boring rotary drill bit having a particle-matrix composite bit body and an insert or inserts to improve resistance to cracking within the bit body is disclosed. The inserts provide improved crack resistance through at least two mechanisms. The first mechanism includes establishing a mismatch in the CTE of the inserts and the particle-matrix composite material. Upon a change of temperature, such as would typically occur during drilling, the CTE mismatch between the inserts and the particle-matrix composite establishes areas of localized compressive stress within the drill bit body proximate the inserts, thereby toughening the particle-matrix composite material and increasing its resistance to cracking in these regions. The localized compressive stresses that occur in the particle-matrix composite material are generally higher at the interface between the particle-matrix composite and the insert and progressively reduced away from this interface in the matrix material, as illustrated schematically by force vectors (F) in FIG. 6. Secondly, in some cases, an insert may bridge a crack 9 or be placed in the path of a crack or potential site at which cracking may occur, such that this bridge spans the crack or potential crack path tending to limit the ability of the crack to open, thereby also limiting or constraining either or both of the initiation and propagation of the crack. For example, if an insert is proximate a potential crack initiation site, such that it lies in the path in which the crack would tend to initiate, the insert will have a tendency to resist the initiation of a crack at this location. In another example, if a crack has already initiated and has begun to propagate, an insert which lies in the path of the propagating crack, may blunt the crack and prevent its further progress, or if the crack is of sufficient size that it may propagate around the insert, the insert will have a tendency to bridge the crack and resist its further opening, thereby limiting or restricting the further propagation of the crack, as illustrated schematically in FIG. 4.

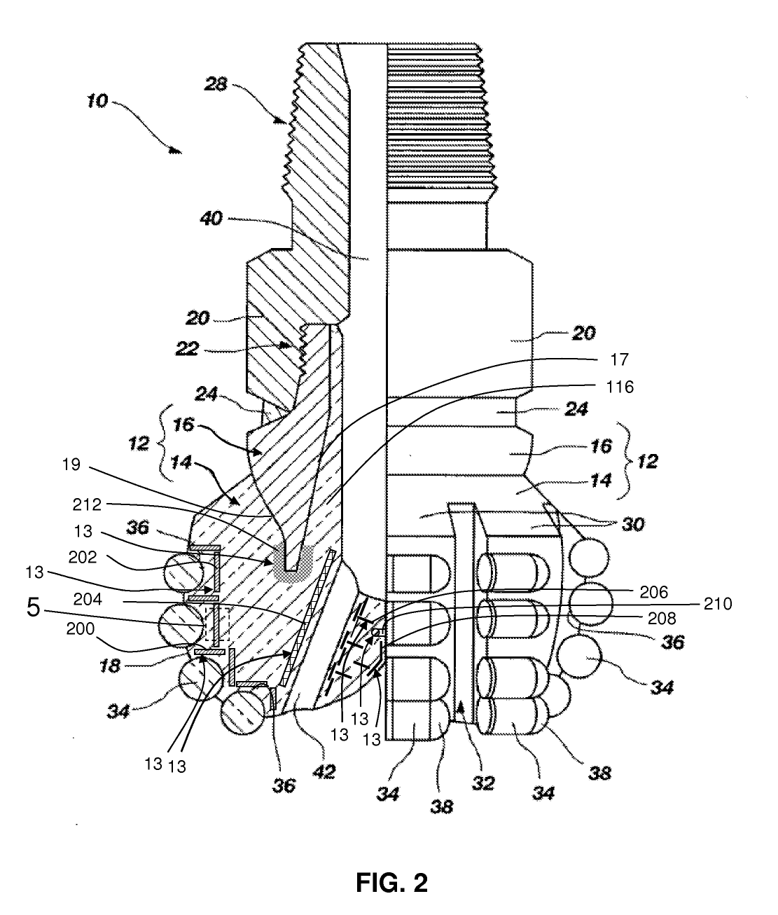

An exemplary embodiment of an earth-boring rotary drill bit 10 having a bit body 12 that includes a particle-matrix composite material 116, where the composite also includes a plurality of inserts 13 to enhance the crack resistance of the bit body 12, is illustrated in FIG. 2. The bit body 12 is secured to a shank 20, such as a steel shank. The bit body 12 includes a crown 14, and a metal blank 16 that is partially embedded in the crown 14.

The crown 14 includes a particle-matrix composite material 116. Many other configurations of rotary drill bit 10 are possible including configurations in which the bit body 12 is not secured to a metal blank, such as metal blank 16, but rather is secured directly to a shank (not shown). Other configurations include those in which the bit body 12 has formed therein an integral metal blank, or includes a portion of the bit body that is suitable for use in the same manner as a metal blank, which is in turn secured to a shank. Still other configurations include those in which the bit body includes an integrally formed shank for attachment to the drill string. These and many other drill bit configurations are possible that employ a particle-matrix composite 116 as the bit body 12. All such configurations incorporating a particle-matrix composite 116 material in the bit body may employ inserts, such as inserts 13, to enhance the crack resistance of the bit body.

The particle-matrix composite material 116 may include any suitable particle-matrix composite material 116 that has the characteristics and material properties described herein in relation to the insert. In an exemplary embodiment, the matrix material may include a pure metal or metal alloy. In another exemplary embodiment, the matrix material may include a Cu alloy, and more particularly a Cu—Mn—Zn alloy. Suitable Cu alloys, including Cu—Mn—Zn alloys, are described in U.S. Pat. No. 5,000,273, which is hereby incorporated by reference herein in its entirety. This patent describes a binder (matrix) comprising about 5-65% by weight of manganese, up to about 35% by weight of zinc, and the balance copper. More particularly, it describes a binder comprising 20-30% by weight of manganese, about 10-25% zinc, and the balance copper. Even more particularly, it describes a binder comprising about 20% by weight of manganese, about 20% by weight of zinc and the balance copper, as well as a binder composition comprising about 20% by weight of manganese, about 25% by weight of zinc, and the balance copper. The binder alloys described in this patent may also comprise up to about 5% of an additional alloying element, where the alloying element is selected from the group consisting of silicon, tin and boron, and combinations thereof. Another exemplary Cu—Mn—Zn alloy also comprises Ni as an alloying constituent, more particularly Ni in an amount up to about 16% by weight. The matrix materials of the particle-matrix composite 116 have a characteristic CTE, which will in general be different than the CTE of the particle-matrix composite material 116, due to the influence of the hard particles in the particle-matrix composite 116. In an exemplary embodiment, the CTE of the particle-matrix composite 116 may be less than the CTE of the matrix material alone, as further described herein.

Many metals and metal alloys, including the various Cu alloy material compositions described herein, may be used as the matrix material for crown 14, and any suitable combination of particles and matrix materials may be used to make the particle-matrix composite material 116 of crown 14. The particle-matrix composite material of the crown 14 may include a plurality of hard particles dispersed randomly throughout the matrix material. The hard particles may comprise diamond or ceramic materials such as various carbides, nitrides, oxides, and borides (including boron carbide (B₄C)) and combinations of them, such as carbonitrides. More specifically, the hard particles may comprise carbides and borides made from elements such as W, Ti, Mo, Nb, V, Hf, Ta, Cr, Zr, Al, or Si. By way of example and not limitation, materials that may be used to form hard particles include tungsten carbide (WC, W₂C), titanium carbide (TiC), tantalum carbide (TaC), titanium diboride (TiB₂), chromium carbides, titanium nitride (TiN), vanadium carbide (VC), aluminum oxide (Al₂O₃), aluminum nitride (AlN), boron nitride (BN), and silicon carbide (SiC). In an exemplary embodiment, when using Cu alloy materials as the matrix, it is particularly desirable to use tungsten carbide particles in the various morphologies described herein to form the particle-matrix composite material 116. Furthermore, combinations of different hard particles may be used to tailor the physical properties and characteristics of the particle-matrix composite material 116. In particular, in a particle-matrix composite material 116, the CTE of the matrix material may be influenced by the presence of the hard particles, particularly where the CTE of the hard particles is lower than the CTE of the matrix material. For example, the CTE of hard particles of the types described are generally less than about 10 ppm/° C. As a further example, in a tungsten carbide-copper alloy particle-matrix composite, the CTE of the particle-matrix composite 116 may be about 12 ppm per ° C., which is less than the CTE of Cu or Cu alloys of about 16-20 ppm/° C. due to the influence of the hard particles on the matrix material. Thus, in an exemplary embodiment, the CTE of the particle-matrix composite 116 may be less than the CTE of the alloy used as the matrix material alone. The hard particles may be formed using techniques known to those of ordinary skill in the art. Most suitable materials for hard particles are commercially available and the formation of the remainder is within the ability of one of ordinary skill in the art.

As described herein, a bit body 12 is configured to carry one or more cutters 34 for engaging a subterranean earth formation. The bit body 12 includes a particle-matrix composite material 116 as described herein having a plurality of hard particles dispersed throughout a matrix material, where the composite material 116 has a first CTE associated therewith.

The bit body 12 also has an insert 13 disposed in the bit body. Insert 13 has a second CTE that is greater than the first CTE, namely that of the particle-matrix composite material 116. Because insert 13 is disposed in the hard particles prior to infiltration of the matrix material, insert 13 is formed from a material having a melting point that is higher than the melting point of the matrix material, in order to avoid melting of insert 13 during the infiltration process, as described herein. It is also preferred that the material used for insert 13 have at most limited solubility in the matrix material over the temperature range experienced during the infiltration process. It is also preferred that the insert 13 form a metallurgical bond at its surface 15 and interface with the matrix material, hard particles or both of them. In the case of Cu alloy matrix materials, this temperature range is generally less than about 1200° C., and more particularly less than about 1150° C. This is to avoid excessive dissolution of the insert in the matrix material during the infiltration process, and more preferably to reduce the propensity for the insert material to dissolve in the matrix material as much as possible by appropriate selection of the material for inserts 13 as well as the matrix material.

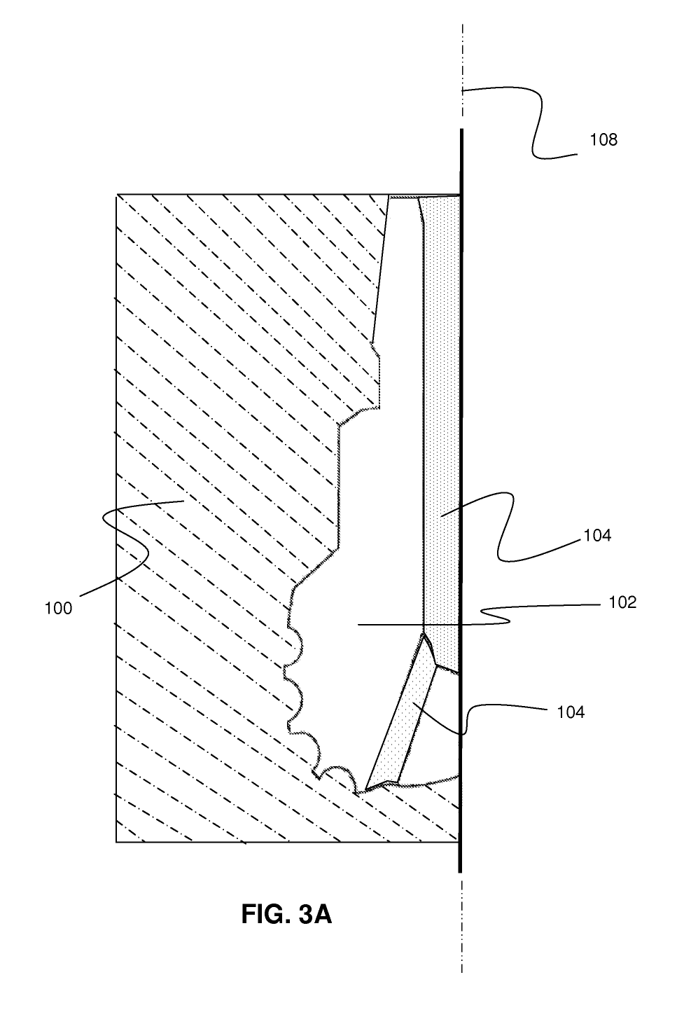

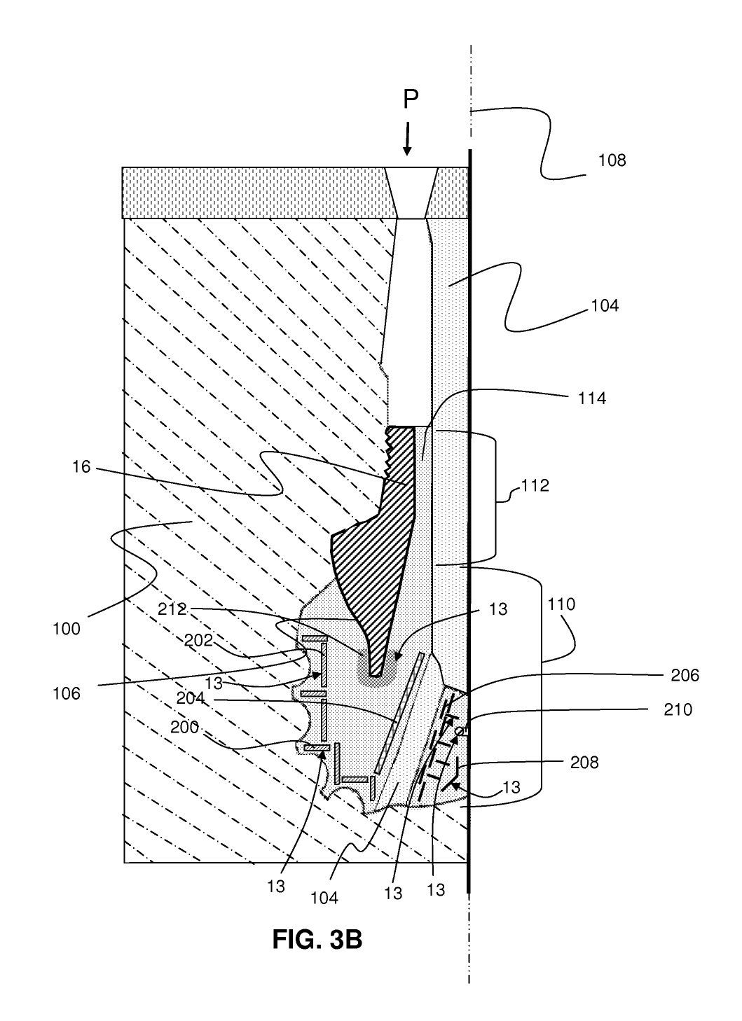

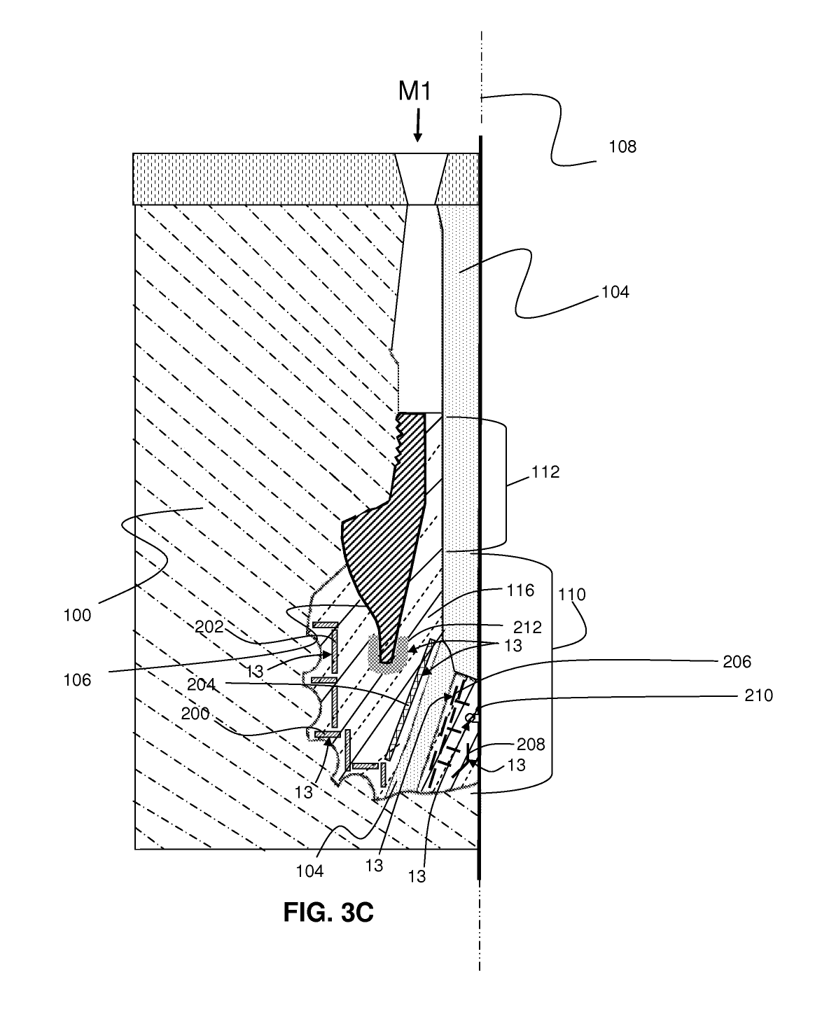

Referring to FIGS. 3A-C and 4, to avoid dissolution or chemical interaction during infiltration or otherwise improve the insert/particle-matrix composite interface, the insert surface 15 may also be coated prior to infiltration with a thin layer or layers of a coating material 17. In an exemplary embodiment, the thin layer of the coating material 17 may comprise a diffusion barrier layer, that is selected to prevent, or alternately to slow, chemical interaction, including diffusion or dissolution processes, between the inserts 13 and the matrix or hard particle materials at the temperatures associated with the infiltration of the matrix material. The coating material 17 will be selected to achieve this result based on the materials selected for use as the matrix and hard particles. In an exemplary embodiment, where the matrix material comprises copper or a copper alloy and the hard particles comprise tungsten carbide, the coating material may include Cr, Ti or Ta, or alloys of these metals, or oxides, nitrides or carbides of these metals, or a combination thereof. In another exemplary embodiment, the thin layer of the coating material may include a layer of a sacrificial material having dissolution characteristics with respect to the matrix material, hard particles and insert 13 that preserve the integrity of the insert 13 at the temperatures associated with the infiltration of the matrix material while the layer of the coating material is sacrificed by partial or complete dissolution or diffusion therein. In the case of both diffusion barrier layers and sacrificial layers, it is preferred that the material selected provide a metallurgical bond to both the material of the insert and the matrix, hard particles or both of them where insert 13 includes a layer of coating material 17, the use of the term “insert” may include the insert and coating material.

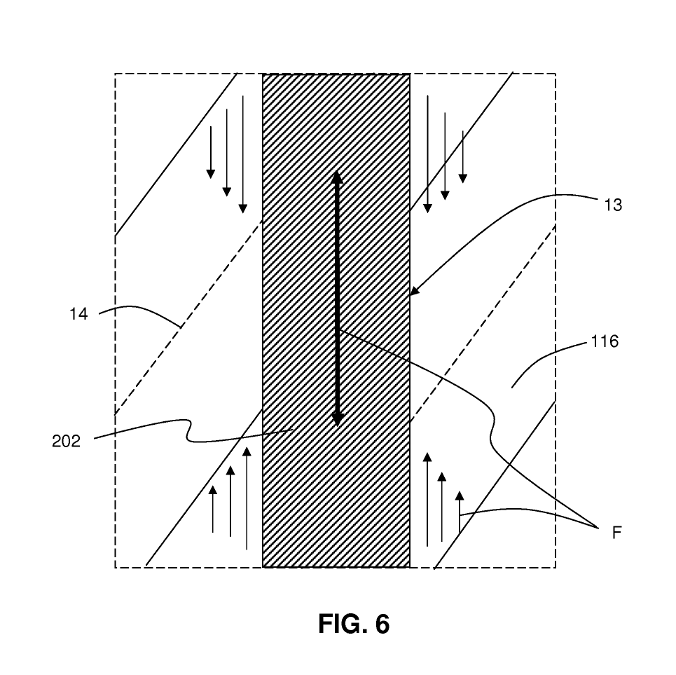

In an exemplary embodiment, where the matrix material includes a Cu alloy and tungsten carbide hard particles, insert 13 may be formed from a material having a CTE greater than about 12 ppm/° C. and a melting point which is higher than that of the Cu alloy of the matrix material, and more particularly may include austenitic stainless steels, Cr—Ni—Fe alloys, Ni-based superalloys, Co-based superalloys, Fe-based superalloys, Cr—Ni—Co—Fe superalloys, nodular or ductile iron alloys, carbon free cutting steels, alloy steels, age-hardenable stainless steels, high temperature steels, ultra high strength steels, Cu—Ni alloys, Cu—Ag alloys, Al bronzes, Ni, Ni alloys, Ag, Ag alloys, Mn, Mn alloys, or a combination thereof. Referring to FIG. 5, these materials each have a CTE which is greater than the CTE of a tungsten carbide-copper alloy particle-matrix composite material, namely about 12 ppm/° C. More generally, where other matrix materials are employed, insert 13 may be formed from a pure metal or a metal alloy having a CTE that is greater than the CTE of the particle-matrix composite material 116. Insert 13 may have any suitable form for reducing the propensity of crack initiation, propagation, or both of them, in a particular particle-matrix composite material 116. Suitable forms include various particle, rod, needle, wire, fiber (continuous or discontinuous), mesh, disk, ring or plate forms, or the like, or a combination of these forms. Particle forms may have any shape and size, including spherical shapes, pellet shapes, and the like. In the case of fibers, discontinuous fibers may include randomly oriented, chopped fibers, or fibers arranged in a tow or other non-randomly oriented structure or form. These forms may be used as inserts in any size, shape, or form that is useful for enhancing the crack resistance of the particle-matrix composite material 116. The use of some of these forms is illustrated in FIG. 2. As examples, an insert 13, comprising a plate 200 or rod 202 may be located proximate cutter pockets 36. A mesh 204 may be used proximate to nozzle (not shown)/port 42. Fibers 206 or wires 208 may be located within blade 30. A ring 210 may be disposed proximate the root of blade 30. Insert 13 may be disposed in any portion of bit body 12 that enhances its resistance to cracking. In an exemplary embodiment, insert 13 is disposed in a portion or location of the bit body 12 having a propensity for initiation or propagation of a crack. The propensity for initiation or propagation of a crack and the placement and location of insert 13 may be assessed by any suitable method, including finite element or other computer modeling methods used to model stress and strain within bit body 12 and crown 14, or alternately, may be assessed by empirical methods, including examination of bit bodies that have been used for earth-boring and have been observed to exhibit cracking, or which have failed as a result of catastrophic propagation of the crack through the bit body. In an exemplary embodiment, insert 13 is disposed proximate a cutter pocket 36, a nozzle port 42 or a bit body blade 30, or a combination thereof. As illustrated in FIG. 2, insert 13 may include a single insert, or may include a plurality of inserts 13 disposed at one or more locations within bit body 12 and crown 14.

As illustrated in FIG. 2, the bit body 12 is secured to the steel shank 20 by way of a threaded connection 22 and a weld 24 extending around the drill bit 10 on an exterior surface thereof along an interface between the bit body 12 and the steel shank 20. The steel shank 20 includes an API threaded connection portion 28 for attaching the drill bit 10 to a drill string (not shown).

The bit body 12 includes wings or blades 30, which are separated by external channels or conduits also known as junk slots 32. Internal fluid passageways 42 or nozzle ports extend between the face 18 of the bit body 12 and a longitudinal bore 40, which extends through the steel shank 20 and partially through the bit body 12. Nozzle inserts (not shown) may be provided at face 18 of the bit body 12 within the internal fluid passageways 42.

A plurality of polycrystalline diamond compact (PDC) cutters 34 may be provided on the face 18 of the bit body 12. The PDC cutters 34 may be provided along the blades 30 within pockets 36 formed in the face 18 of the bit body 12, and may be supported from behind by buttresses 38, which may be integrally formed with the crown 14 of the bit body 12.

The metal blank 16 shown in FIG. 2 is generally cylindrically tubular. Alternatively, the metal blank 16 may have a fairly complex configuration and may include external protrusions corresponding to blades 30 or other features on and extending on the face 18 of the bit body 12 (not shown), or a plurality of annularly or radially spaced slots or other features that extend through the annular wall of blank 16 which facilitate continuity of the particle-matrix composite material between an inner surface 17 and outer surface 19 of metal blank 16. By way of example and not limitation, metal blank 16 may comprise a ferrous alloy, such as steel.

During drilling operations, the drill bit 10 is positioned at the bottom of a wellbore and rotated while drilling fluid is pumped to the face 18 of the bit body 12 through the longitudinal bore 40 or nozzle and the internal fluid passageways 42. As the PDC cutters 34 shear or scrape away the underlying earth formation, the formation cuttings mix with and are suspended within the drilling fluid and pass through the junk slots 32 and the annular space between the wellbore and the drill string to the surface of the earth formation.

A method of making earth boring rotary drill bits having multi-layer particle-matrix composite bit bodies of the type described herein is described in FIGS. 3A-3C. Referring to FIG. 3A, bit bodies that include a particle-matrix composite material, such as those described herein, may be fabricated in graphite molds 100. The cavities 102 of the graphite molds may be conventionally machined with a five-axis machine tool. Fine features may then be added to the cavity of the graphite mold by hand-held tools or by other suitable means. Additional clay work may also be required to obtain the desired configuration of some features of the bit body. Where necessary, preform elements or displacements 104 (which may include ceramic components, graphite components, resin-coated sand compact components and the like) may be positioned within the mold and used to define the internal passageways 42, cutting element pockets 36, junk slots 32, and other external topographic features of the bit body (FIG. 2).

The cavity 102 of the graphite mold is filled, as shown by arrow P, with hard particulate material 106, such as tungsten carbide particles, of the types described herein as shown in FIG. 3B. This may include particulate material with a single range of sizes throughout, or a single material with a plurality of size ranges along the depth of cavity 102 (i.e., along its longitudinal axis 108). The hard particles may also comprise a plurality of different hard particle materials. For example, the hard particles may have a first hard particle composition, size distribution or both in the first region of the mold 110 and a different hard particle composition, size distribution or both in the second region 112. Further, the hard particles may include more than two hard particle compositions, size distributions, or both, in any number. Once loaded into the mold cavity 102, hard particles 106 may be compacted or otherwise densified, such as by vibrating the mold, to decrease the amount of space between adjacent particles of the particulate material and form particle precursor 114 that will be infiltrated by the respective matrix materials in the manner described herein. A preformed metal blank 16 (FIG. 3B) may then be positioned in an upper portion of the mold at the appropriate location and orientation. When employed, an insert such as metal blank 16 typically is at least partially embedded in the particulate material within the mold.

In conjunction with providing a plurality of hard particles in the mold to define the particle precursor of the bit body for infiltration by a molten matrix material, the method also includes disposing an insert 13 within the particle precursor. In an exemplary embodiment, this may be done successively by filling the mold with hard particles to a certain depth, insertion of one or more inserts 13, followed by further filling of the mold with hard particles. In another exemplary embodiment, hard particles and inserts may be inserted into the mold at the same time. For example, incorporation of a random array of fibers or wires may be provided by filling the mold with both the particles and fibers at the same time. The insert or inserts 13 will be disposed within cavity 102 at locations and in orientations that will impede cracking within the bit body 12 to be formed by infiltration of the matrix material, particularly during use of bit body 12 in conjunction with drilling.

A matrix material, such as, for example, a Cu-alloy, is melted and poured into the mold cavity as illustrated by arrow Ml. The particulate precursor 114 is infiltrated with the molten matrix material Ml to form a molten particle-matrix material mixture 116. The mold and bit body 12 may be cooled to solidify the matrix material and form the particle-matrix composite 116.

Referring to FIGS. 3B and 3C, upon filling the mold cavity and infiltrating particulate precursor 114, the molten particle-matrix material mixture, is cooled from an initially stress-free state to solidify the matrix materials and form a particle matrix composite 116 having inserts 13 disposed therein.

Referring again to FIG. 1, the mold may also include metal blank 16. Upon solidification, the metal blank 16 and inserts 13 are metallurgically bonded to the particle-matrix composite material.

Once the bit body 12 has cooled, the bit body 12 is removed from the mold and any displacements are removed from the bit body 12. Destruction of the graphite mold may be required to remove the bit body 12.

After the bit body 12 has been removed from the mold and any secondary operations desired to form the bit body 12, or optional metal blank 16, have been employed, such as machining or grinding, the bit body 12 may be secured to the steel shank 20. As the particle-matrix composite material 116 used to form the crown 14 is relatively hard and not easily machined, the metal blank 16 may be used to secure the bit body to the shank. Threads may be machined on an exposed surface of the metal blank 16 to provide a threaded connection 22 between the bit body 12 and the steel shank 20 as shown in FIG. 1. The steel shank 20 may be threaded onto the bit body 12, and a weld 24 then may be provided along the interface between the bit body 12 and the steel shank 20.

The PDC cutters 34 may be bonded to the face 18 of the bit body 12 after the bit body 12 has been cast by, for example, brazing, mechanical, or adhesive affixation. Alternatively, the cutters 34 may be bonded to the face 18 of the bit body 12 during forming of the bit body 12 if thermally stable synthetic or natural diamonds are employed in the cutters 34.

During all infiltration or casting processes, refractory structures or displacements 104 may be used to support at least portions of the bit body and maintain desired shapes and dimensions during the solidification process. Such displacements may be used, for example, to maintain consistency in the size and geometry of the cutter pockets 36 and the internal fluid passageways 42 during the sintering process. Such refractory structures may be formed from, for example, graphite, silica, or alumina. The use of alumina displacements instead of graphite displacements may be desirable as alumina may be relatively less reactive than graphite, thereby minimizing atomic diffusion during solidification. Additionally, coatings such as alumina, boron nitride, aluminum nitride, or other commercially available materials may be applied to the refractory structures to prevent carbon or other atoms in the refractory structures from diffusing into the bit body during solidification.

While the description herein presents certain preferred embodiments, those of ordinary skill in the art will recognize and appreciate that it is not so limited. Rather, many additions, deletions and modifications to the preferred embodiments may be made without departing from the scope of the invention as hereinafter claimed. In addition, features from one embodiment may be combined with features of another embodiment while still being encompassed within the scope of the invention as contemplated by the inventors. Further, the invention has utility in drill bits and core bits having different and various bit body profiles as well as cutter types.

The foregoing invention has been described in accordance with the relevant legal standards, thus the description is exemplary rather than limiting in nature. Variations and modifications to the disclosed embodiments may become apparent to those skilled in the art. Accordingly, the scope of legal protection afforded will be determined in accordance with the following claims.

We claim:

1. A method of making an earth-boring rotary drill bit comprising a bit body configured to carry one or more cutters for engaging a subterranean earth formation, comprising:
providing a plurality of hard particles in a mold to define a particle precursor of the bit body; wherein the particle precursor is configured for infiltration by a molten matrix material, the resulting particle-matrix composite material having a first coefficient of thermal expansion;
disposing an insert within the particle precursor, the insert having a second coefficient of thermal expansion that is greater than the first coefficient of thermal expansion;
infiltrating the particle precursor of the bit body and insert with the molten matrix material; and
cooling the molten particle-matrix mixture to solidify the molten matrix material and form a bit body comprising a particle-matrix composite material having a plurality of hard particles and an insert disposed in the matrix material.

2. The method of claim 1, wherein the insert comprises a material having a melting point that is higher than a melting point of the matrix material.

3. The method of claim 2, wherein the insert comprises a pure metal or a metal alloy.

4. The method of claim 1, wherein the matrix material comprises a Cu alloy.

5. The method of claim 1, wherein the matrix material comprises a Cu—Mn—Zn alloy.

6. The method of claim 4, wherein the insert comprises austenitic stainless steel, Cr—Ni—Fe alloy, Ni-based superalloy, Co-based superalloy, Fe-based superalloy, Cr—Ni—Co—Fe superalloy, nodular or ductile iron alloy, carbon free cutting steel, alloy steel, age-hardenable stainless steel, high temperature steel, ultra high strength steel, Cu—Ni alloy, Cu—Ag alloy, Al bronze alloy, Ni, Ni alloy, Ag, Ag alloy, Mn, Mn alloy, or a combination thereof.

7. The method of claim 1, wherein the insert comprises a particle, rod, needle, wire, fiber, mesh, disc, or plate, or a combination thereof.

8. The method of claim 1, wherein the insert is disposed in a portion of the bit body having a propensity for propagation of a crack.

9. The method of claim 1, wherein the insert is disposed proximate a cutter pocket, a nozzle port or a bit body blade, or a combination thereof.

10. The method of claim 1, further comprising applying a layer of a coating material on a surface of the insert prior to disposing the insert within the particle precursor.
